(19) United States
(12) Patent Application Publication
(10) Pub. No.: US 2003/0121021 A1
(43) Pub. Date: Jun. 26, 2003

(54) System and method for determining manufacturing error enhancement factor

(75) Inventors: Hua-Yu Liu, Palo Alto, CA (US); Chi-Ming Tsai, Palo Alto, CA (US); Yao-Ting Wang, Atherton, CA (US)

Correspondence Address: NUMERICAL, C/O BEVER HOFFMAN & HARMS, LLP, 2099 GATEWAY PLACE, SUITE 320, SAN JOSE, CA, 95110-1017, US

(73) Assignee: Numerical Technologies, Inc., San Jose, CA

(21) Appl. No.: 10/033,054

(22) Filed: Dec. 26, 2001

(51) Int. Cl. G06F 17/50

(52) U.S. Cl. 716/19

(57) ABSTRACT

A method and system of determining a sensitivity of an edge of a feature to mask error can be advantageously provided using information from multiple simulations. Input data as well as revised data regarding the edge can be used, wherein the revised data includes a first mask error. The input data can be simulated to generate first deviation information, whereas the revised data can be simulated to generate second deviation information accounting for the first mask error. The sensitivity of the edge to mask error can be generated using the first deviation information, the second deviation information, and the first mask error. Specifically, generating the sensitivity can include subtracting the first deviation information from the second deviation and dividing the difference by the first mask error.

### BACKGROUND OF THE INVENTION

1. Field of the Invention

The invention relates to a simulation that determines a silicon result from input data, and particularly to an additional simulation incorporating a first mask error that determines a manufacturing error enhancement factor.

2. Description of the Related Art

In designing an integrated circuit (IC), engineers create a circuit schematic design consisting of individual devices coupled together to perform a certain function. To actually fabricate this circuit on a wafer, the circuit must be translated into a physical representation, or layout, which itself can then be transferred onto a physical template, e.g. a mask or a reticle. For ease of reference, the term “mask” shall refer to either a mask or a reticle.

A mask, e.g. a quartz plate patterned with chrome, is generally created for each layer of the IC design. The mask can then be used in a lithographic process to project its pattern onto a silicon wafer coated with photoresist material. Specifically, for each layer of the design, radiation is projected onto the mask corresponding to that layer. The radiation passes through the clear regions of the mask, whose image exposes the underlying photoresist layer, and is blocked by the opaque regions of the mask, thereby leaving that underlying portion of the photoresist layer unexposed. The exposed photoresist layer is then developed, typically through chemical removal of the exposed/non-exposed regions of the photoresist layer. The result is a wafer coated with a photoresist layer exhibiting the desired pattern, which defines the geometries, features, lines and shapes of that layer. This process is then repeated for each layer of the design.

Because a mask can be repeatedly used in creating thousands or even hundreds of thousands of ICs, the feature dimension control of a mask is an area of great concern. In other words, any error in feature dimension on a mask is propagated to any wafer printed using that mask. Such errors can be particularly pronounced when a 1× exposure system prints features on the wafer having the same size as those on the mask.

Another type of exposure system, a reduction system prints features on the wafer with a demagnification factor. For example, a 4× reduction system prints features on the wafer that are ¼ the size of those on the mask. A reduction system affects the printing of error-free features as well as features with critical dimension (CD) errors.

However, the benefit of reducing the size of mask errors is diminished when sub-wavelength features are being printed. In that case, the mask error typically results in a feature printing larger on the wafer by a certain amplification. This amplification, called a mask error factor (MEF), or alternatively, a mask error enhancement factor (MEEF), both referred to herein as MEEF, has the following general relationship to a change in critical dimension:

$$MEEF = \frac{Δ {CD}_{wafer}}{Δ {CD}_{mask / M}}$$

wherein M is the demagnification factor (e.g. M=4 in the case of a 4× reduction system). A higher MEEF indicates an increased sensitivity to mask error whereas a lower MEEF indicates a decreased sensitivity to mask error.

Of importance, certain features on the mask may be more sensitive to mask error than other features. Although users recognize the importance of mask error to the printed features on the wafers, tools have not been provided to allow the users to determine which regions of the mask are, in fact, more sensitive to mask error. Having such information would allow users, e.g. mask and wafer inspection facilities, to focus their expensive equipment and personnel on the specific areas of the mask/wafer that are more sensitive to such mask error. Additionally, the amount of OPC bias to be applied can be estimated using MEEF and deviation.

Therefore, a need arises for a manner of measuring this sensitivity, i.e. MEEF. A need further arises for a method of providing accurate MEEFs for selected features on each mask.

### SUMMARY OF THE INVENTION

A method of determining a sensitivity of an edge of a wafer feature to mask error can be advantageously provided using information from multiple simulations. In accordance with one aspect of the invention, the method can include receiving input data as well as automatically generating revised data, wherein the revised data includes a first mask error. The input data can be simulated to generate first deviation information, whereas the revised data can be simulated to generate second deviation information accounting for the first mask error. The sensitivity of the wafer edge to mask error can be generated using the first deviation information, the second deviation information, and the first mask error. (The term wafer will be omitted from the phrase “wafer edge” or “edge of a wafer feature”, as the meaning is apparent from context throughout this discussion. Note that although the concern is sensitivity of the wafer edge to mask error, this sensitivity can be determined by analysis of an associated edge on a layout or a mask.) Specifically, generating the sensitivity can include subtracting the first deviation information from the second deviation and dividing the difference by the first mask error.

In another embodiment, the revised data can include two or more mask errors, e.g. a size-up mask error and a size-down mask error. In this embodiment, the size-up and size-down mask error values with the revised data can be used to generate the first and second deviation information. That information can then be used to compute MEEF.

Although embodiments can be described as computing MEEF in terms of the deviation, the deviation can be computed from absolute positions determined by simulation. Alternatively, the absolute positions determined by simulation, e.g. for the size-up and size-down mask error, can directly be used to compute MEEF as a slope.

In one embodiment, the input data can include an edge of a layout feature and the revised data can include the layout edge and a border representing the first mask error. In another embodiment, the input data can include an edge of a mask feature and the revised data can include the mask edge and a border representing the first mask error. This mask edge may have been corrected for optical proximity.

In one embodiment, multiple mask errors can be used. Assuming both first and second mask errors are provided, simulating the revised data includes simulating the revised data with the first mask error as well as simulating the revised data with the second mask error. Results from one or both of these simulations can be used to generate the second deviation information. In one case, the higher or lower of the results from the two simulations can be used. In another embodiment, an average of the results from the simulations can be used.

A system of determining a sensitivity of an edge of a feature to mask error is also provided. The system can include a simulation tool, which receives either layout or mask input data regarding the edge. The simulation tool can further include means for using a first mask error and the input data to generate the sensitivity. In accordance with one feature of the invention, the means for using can include means for simulating the input data to generate first deviation information, means for simulating revised data (which includes the input data and the first mask error) to generate second deviation information, and means for calculating the sensitivity using the first deviation information, the second deviation information, and the first mask error. In one embodiment, the first mask error includes a plurality of mask errors. In such a case, the means for simulating revised data generates the second deviation information using the plurality of mask errors.

An input file to an inspection system is also provided. The input file advantageously includes references to regions that have associated high mask error enhancement factors, wherein a high mask error enhancement factor indicates a sensitivity to mask error. In one embodiment, the input file can also include references to regions that have associated low mask error enhancement factors, wherein a low mask error enhancement factor indicates an insensitivity to mask error. The regions can be referenced on a layout or on a lithographic mask.

A computer program product is also included. The computer program product can include a computer usable medium having a computer readable program code embodied therein for causing a computer to analyze an edge of a feature for sensitivity to mask error, the edge being on one of a layout and a mask. The computer readable program code comprises computer readable program code that receives input data regarding the edge, computer readable program code that receives revised data regarding the edge (wherein the revised data includes a first mask error), computer readable program code that simulates the input data to generate first deviation information, computer readable program code that simulates the revised data to generate second deviation information, and computer readable program code that generates the sensitivity using the first deviation information, the second deviation information, and the first mask error. Specifically, the computer readable program code that generates the sensitivity subtracts the first deviation information from the second deviation, and divides the difference by the first mask error. In one embodiment, the input data includes an edge of a layout feature and the revised data includes the layout edge and a border representing the first mask error. In another embodiment, the input data includes an edge of a mask feature and the revised data includes the mask edge and a border representing the first mask error.

A method of inspecting a mask/wafer including a plurality of features is also provided. The method can include determining a subset of the plurality of features, wherein the subset exhibits a sensitivity to mask error. Advantageously, the subset of the plurality of features can be inspected before other features on the mask/wafer. Determining the subset can include receiving input data as well as revised data regarding an edge of the feature, wherein the revised data includes a first mask error. The input data can be simulated to generate first deviation information and the revised data can be simulated to generate second deviation information based on the first mask error. A mask error enhancement factor (MEEF) can be generated using the first deviation information, the second deviation information, and the first mask error. A high MEEF indicates sensitivity to mask error. Generating the MEEF includes subtracting the first deviation information from the second deviation and dividing the difference by the first mask error.

### BRIEF DESCRIPTION OF THE DRAWINGS

FIG. 1 illustrates a feature provided on a layout and a contour indicating its corresponding printed feature perimeter provided by simulation and assuming no mask error enhancement factor.

FIG. 2 illustrates a feature provided on a layout and a contour indicating its corresponding printed feature perimeter provided by simulation and assuming a mask error enhancement factor.

FIG. 3 illustrates a generalized system that can determine the sensitivity of a feature to mask error.

FIG. 4 illustrates a process that can be used with the system of FIG. 3.

FIG. 5 illustrates the case where the mask error causes a layout feature to be smaller on the wafer than the layout, i.e. a size-down mask error.

### DETAILED DESCRIPTION OF THE DRAWINGS

One industry tool, the SiVL® software, licensed by Numerical Technologies, Inc., can verify a simulated silicon result for an input layout against that layout. To provide this verification, the tool uses a user's layout and various process effects, such as optical, chemical, and etch effects, to generate a simulated wafer image. The SiVL software can then compare this simulated wafer image with the user's layout and report out-of-tolerance regions. In one embodiment, an out-of-tolerance region can be graphically indicated by a contour that represents the perimeter of the simulated wafer image lined up with the associated feature of the user's layout.

In the SiVL software, the edges of the features in the layout can be biased to compensate for optical proximity effects. According to one technique, edges of features in a layout are dissected into segments defined by dissection points, wherein each segment has zero or more checking points. Most segments are assigned a single checking point according to one embodiment of the invention. The spacing of checking points and dissection points can be automatically adapted to portions of each edge where changes in the layout are most likely needed. In one embodiment, dissection points are closer together where proximity effects are more significant and are farther apart where proximity effects are less significant. Thus, unnecessary checking points can be eliminated and the analysis process is speeded up, while still retaining needed checking points. U.S. patent application Ser. No. 09/676,356, filed on Sep. 29, 2000 and entitled, “Selection of Evaluation Point Locations Based on Proximity Effects Model Amplitudes for Correction Proximity Effects in a Fabrication Layout” describes one approach for dissecting edges and placing checking points as needed. In one embodiment, subsequent operations on the edges in the layout, such as biasing for optical proximity correction (OPC), can be performed on the segments, as identified by their respective checking points.

In accordance with one embodiment, the reporting of an out-of-tolerance region can also include illustrating selected checking points for any feature in that region. For example, FIG. 1 illustrates an exemplary report 100 of a layout feature 101, its associated simulated contour 102, and a checking point 103 (a star symbol) that was analyzed with respect to an edge of layout feature 101. If contour 102 falls inside the shaded area of layout feature 101, e.g. see arrow 104, or if contour 102 falls outside the shaded area of layout feature 101, e.g. see arrow 105, then the resulting printed feature is likely to have the wrong shape because of under- or over-exposed photoresist for defining that area of layout feature 101. Report 100 assumes that no mask error is present.

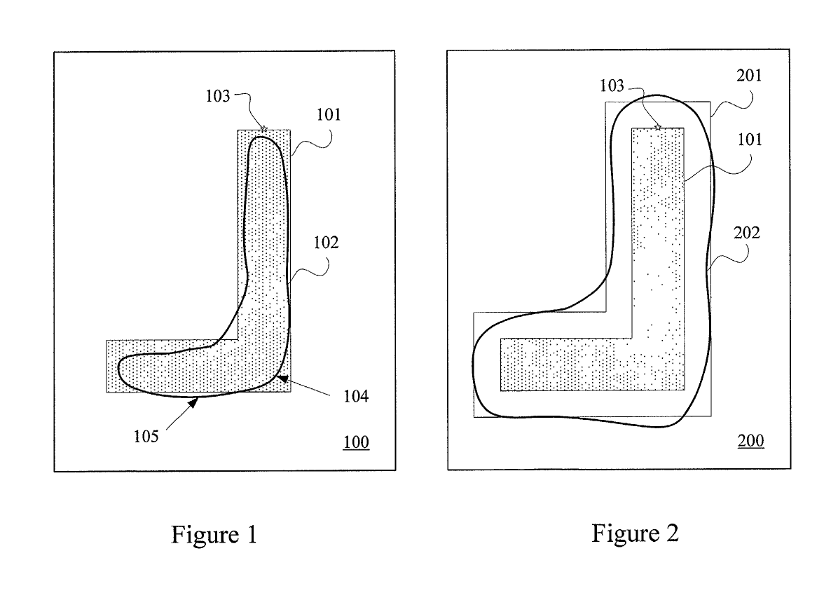

The software tool need not output contours in the formats shown in the reports of FIGS. 1 and 2, or at all. For example the SiVL software generates a modified version of the layout file with markers showing the deviation of the contour at the checking points. The position of the markers should correspond to where the contour would be placed. For example, using the ICWorkbench™ software from Numerical Technologies, Inc., contours of the form shown in FIGS. 1 and 2 can be generated for a small portion of the layout. In contrast, the SiVL software from Numerical Technologies, Inc. is checking much larger portions of the layout and therefore simulation time can be reduced by performing the simulation at the checking points. Note that in some embodiments, the ICWorkbench and the SiVL software can use the same simulation engine. For clarity of illustration of the invention, contours are shown in the figures, but other formats may be used by methods and apparatuses to represent and reflect the effects of MEEF according to embodiments of the invention.

The distance from the checking point to a point on the contour (as measured perpendicular from the associated edge of the feature) is defined as a deviation. In one embodiment, a negative deviation indicates that the contour falls within the shaded area of the layout feature, whereas a positive deviation indicates that the contour falls outside the shaded area of the layout feature. Deviations can be measured or represented in nanometers. In FIG. 1, for example, checking point 103 has a deviation of −3 nm.

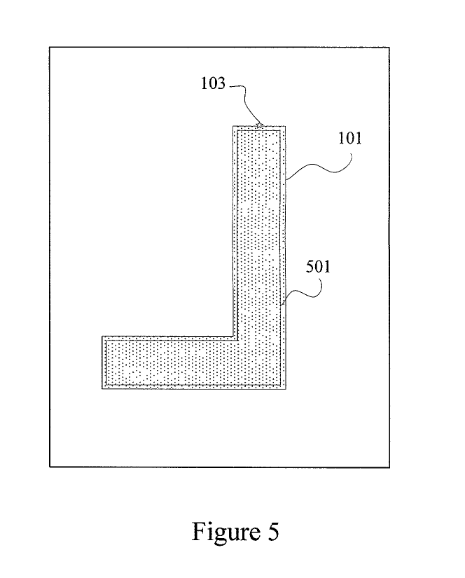

In accordance with one feature of the invention, another simulation can be performed on the layout assuming that a mask error is present. This simulation can provide a new deviation for each checking point. For example, FIG. 2 illustrates an exemplary report 200 including layout feature 101, a border 201 indicating a mask error (shown exaggerated for purposes of illustration, the mask error would generally be closer to the layout), a simulated contour 202 taking into account this mask error, and evaluation point 103. For purposes of illustration, assume that the mask error causes layout feature 101 to be 4 nm larger on the wafer than the layout, i.e. a size-up mask error. Thus, border 201 is formed outside feature 101 and parallel to its edges by a distance 4 nm. FIG. 5 illustrates the case where the mask error causes layout feature 101 to be 1 nm smaller on the wafer than the layout, i.e. a size-down mask error. In this case, a border 501 is formed inside feature 101 and parallel to its edges by a distance of 1 nm.

The mask error can be selected by the user or automatically generated by the simulation tool. As empirically determined, a mask error should be small relative to the critical dimension of the layout, but should not be smaller than the simulation resolution. Therefore, in one embodiment, the selected mask error for user input can be in the range of 1-10 nm for an exemplary process where the critical dimension is 100 nm. In other embodiments, other ranges of mask errors can be generated based on the processes of specific mask shops.

Referring to FIG. 2, note that evaluation point 103 in report 200 has a deviation of +5 nm compared to its deviation of −3 nm in report 100. Because it was assumed that mask error would cause a feature on the mask to be larger than the associated feature provided on the layout, the new deviation is clearly not “predictable” from a user's perspective. Thus, performing the second simulation on the layout assuming mask error provides previously unavailable and sometimes counter-intuitive information.

In accordance with one embodiment, first and second simulations can be performed for each checking point. In another embodiment, these simulations can be performed for selected points (wherein these points could be selected by the user or the simulation tool, either as a representative population or worst case, for example).

To calculate the MEEF of the mask, the following equation can be used:

$$MEEF = \frac{( DEVIATION 2 - DEVIATION 1 )}{INTRODUCED MASK ERROR}$$

wherein DEVIATION 2 refers to the deviation measured during the second simulation assuming a mask error, DEVIATION 1 refers to the deviation measured during the first simulation assuming no mask error, and INTRODUCED MASK ERROR refers to a first mask error chosen for the size-up/size-down. For example, using FIGS. 1 and 2 as results from the first and second simulations, respectively, the MEEF for that feature on the mask would be (5−(−3))/4=2.

In accordance with one feature of the invention, the MEEF provides nanometers of change per one nanometer of mask error, scaled by M. Thus, using the results of the above equation, checking point 103 of layout feature 101 will vary 2 nm for every 1 nm of mask error. In one embodiment, a size-up mask error or a size-down mask error can be assumed for performing the second simulation. In another embodiment, both a size-up mask error and a size-down mask error can be computed, wherein the larger or the smaller of the MEEFs can be used. In yet another embodiment, an average of these two MEEFs can be used.

Irrespective of the type of MEEF calculation used, in accordance with one feature of the invention, the user can advantageously have access to multiple pieces of information for each selected checking point on a feature. Specifically, in addition to the deviation information, the user can view the MEEF of one or more checking points. The higher the MEEF, the more sensitive the edge of the feature is to resolution enhancement techniques (RETs), e.g. optical proximity correction (OPC). In one embodiment, the user can access the MEEF in the same way the user can access the deviation. In another embodiment, different MEEFs can be indicated by different symbols, either represented on the layout or on another layer of the integrated circuit.

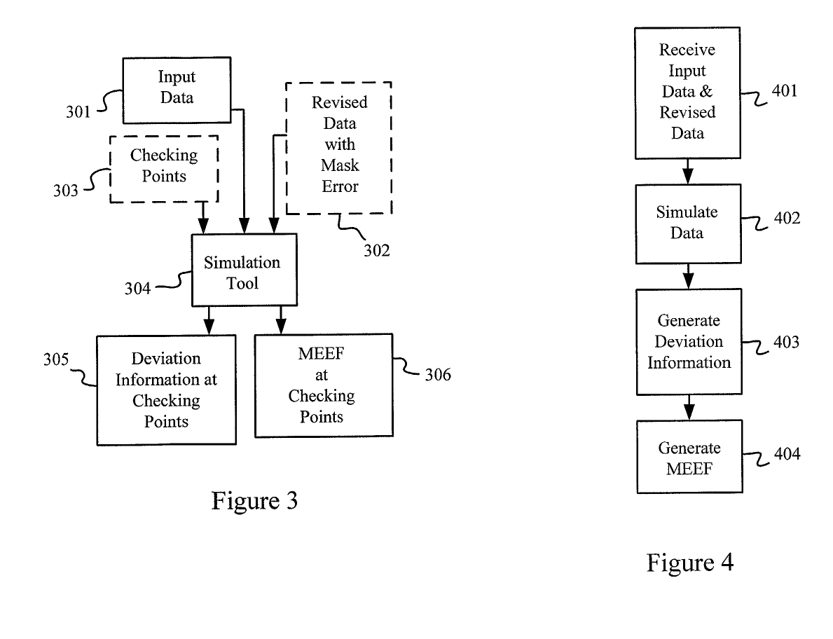

The MEEF information can also be particularly beneficial to inspection facilities to identify problem regions on the mask and/or on a wafer, thereby allowing those facilities to focus their expensive equipment and personnel resources on those regions. Specifically, in one embodiment, the same edges and/or features identified as being sensitive to mask error can be scrutinized on the mask and/or the printed wafer. Note that the input data to the simulation tool can include actual mask data in addition to or in lieu of layout data. FIG. 3 illustrates a generalized system that determines the sensitivity of an edge and/or a feature to a mask error.

In this system, input data 301 including at least one edge of a feature (idealized or actual) can be provided to a simulation tool 304. Note that actual feature data can include optical proximity corrections on a mask, such as hammerheads, serifs, etc. Simulation tool 304 can be implemented using, for example, the SiVL software (receiving layout data) or the Virtual Stepper® System (VSS) software (receiving mask data), both licensed by Numerical Technologies, Inc. Revised data 302 including the at least one edge and a selected mask error can also be provided to simulation tool 304. Finally, one or more checking points 303 can be provided to simulation tool 304. (Note that in one embodiment, simulation tool 304 can determine revised data 302 and checking points 303 in a subprogram.) Thus, using FIG. 2 as an example, revised data 302 would include an edge of feature 101 (e.g. the edge including checking point 103) and a mask error of 4 nm and checking points 303 would include checking point 103. Simulation tool 304 can output deviation information 305 as well as the MEEF 306 at the selected checking point(s).

FIG. 4 illustrates a process that can be used with the system of FIG. 3. In this process, both input and revised data (including mask error) can be received in step 401. In one embodiment, selected checking points can also be provided or generated automatically by the simulation tool. In step 402, the initial data (e.g. layout or mask information) as well as the revised data (i.e. with mask error) can be simulated. These simulations generate at least two sets of deviation information in step 403. Specifically, one set of deviation information is generated for the input data and another set of deviation information is generated for each revised data set. This deviation information in combination with the selected mask error(s) can be used to calculate the MEEF in step 404.

In accordance with one aspect of the invention, knowing the MEEF can optimize processes performed on the layout, the mask, and/or the wafer. For example, if the MEEF is computed before optical proximity correction (OPC) is performed, then the OPC tool can modulate the OPC based on the specific edges on the layout and their sensitivity to change. In another example, if the MEEF is computed before mask/wafer inspection, then the mask/wafer inspection tool can target areas of high sensitivity to change, thereby increasing inspection productivity.

In accordance with another aspect of the invention, the MEEF can be computed during silicon versus layout verification, e.g. using the SiVL® software. In this embodiment, the original layout data and a single revised layout data can be used. In another embodiment, e.g. if the MEEF is being computed apart from critical dimension (CD) checking, it may be advantageous to use two revised layout data sets, e.g. oversized mask error data set and undersized mask error data set, to compute the MEEF.

Although illustrative embodiments of the invention have been described in detail herein with reference to the accompanying figures, it is to be understood that the invention is not limited to those precise embodiments. They are not intended to be exhaustive or to limit the invention to the precise forms disclosed. As such, many modifications and variations will be apparent to practitioners skilled in this art. For example, in one embodiment, MEEF can be computed after optical proximity correction (OPC), wherein the size-up or size-down mask errors would follow the shape of the OPC. In another example, the system and methods described herein can be applied to any lithographic process technology, including ultraviolet, deep ultraviolet (DUV), extreme ultraviolet (EUV), x-ray, and ebeam. Accordingly, it is intended that the scope of the invention be defined by the following Claims and their equivalents.

1. A method of determining a sensitivity of an edge to mask error, the edge forming part of a feature, the method comprising:
receiving input data regarding the edge;
receiving revised data regarding the edge, wherein the revised data includes a first mask error;
simulating the input data to generate first deviation information;
simulating the revised data to generate second deviation information accounting for the first mask error; and
generating the sensitivity using the first deviation information, the second deviation information, and the first mask error.

2. The method of claim 1, wherein generating the sensitivity includes:
subtracting the first deviation information from the second deviation; and
dividing the difference by the first mask error.

3. The method of claim 1, wherein the input data includes one of an edge of a layout feature and an edge of a mask feature.

4. The method of claim 3, wherein the revised data includes one of:
the edge of the layout feature and a border representing the first mask error, and
the edge of the mask feature and a border representing the first mask error.

5. The method of claim 3, wherein the edge of the mask feature has been corrected for optical proximity.

6. The method of claim 1,
wherein receiving revised data regarding the edge includes a first mask error and a second mask error, and
wherein simulating the revised data includes simulating the revised data with the first mask error, simulating the revised data with the second mask error, and using results from at least one of simulating the revised data with the first mask error and simulating the revised data with the second mask error to generate the second deviation information.

7. The method of claim 6, wherein the higher of the results from simulating the revised data with the first mask error and simulating the revised data with the second mask error is used to generate the second deviation information.

8. The method of claim 6, wherein the lower of the results from simulating the revised data with the first mask error and simulating the revised data with the second mask error is used to generate the second deviation information.

9. The method of claim 6, wherein an average of the results from simulating the revised data with the first mask error and simulating the revised data with the second mask error is used to generate the second deviation information.

10. The method of claim 1, further including modulating an optical proximity correction process on the edge based on the MEEF.

11. The method of claim 1, further including targeting an area for inspection based on the MEEF, wherein the area is provided on one of a mask and a wafer that implements the feature.

12. A system of determining a sensitivity of an edge to mask error, the edge forming part of a feature, the system comprising:
a simulation tool including:
means for receiving input data regarding the edge; and
means for using a first mask error and the input data to generate the sensitivity.

13. The system of claim 12, wherein the means for using includes:
means for simulating the input data to generate first deviation information;
means for simulating revised data, which includes the input data and the first mask error, to generate second deviation information; and
means for calculating the sensitivity using the first deviation information, the second deviation information, and the first mask error.

14. The system of claim 13, wherein the first mask error includes a plurality of mask errors, and wherein the means for simulating revised data generates the second deviation information using the plurality of mask errors.

15. An input file to an inspection system, the input file including:
references to regions that have associated high mask error enhancement factors, wherein a high mask error enhancement factor indicates a sensitivity to mask error.

16. The input file of claim 15, wherein the regions are referenced on a layout.

17. The input file of claim 15, wherein the regions are referenced on a lithographic mask.

18. The input file of claim 15, further including references to regions that have associated low mask error enhancement factors, wherein a low mask error enhancement factor indicates an insensitivity to mask error.

19. A computer program product comprising:
a computer usable medium having a computer readable program code embodied therein for causing a computer to analyze an edge of a feature for sensitivity to mask error, the edge being on one of a layout and a mask, the computer readable program code comprising:
computer readable program code that receives input data regarding the edge;
computer readable program code that receives revised data regarding the edge, wherein the revised data includes a first mask error;
computer readable program code that simulates the input data to generate first deviation information;
computer readable program code that simulates the revised data to generate second deviation information based on the first mask error;
and computer readable program code that generates the sensitivity using the first deviation information, the second deviation information, and the first mask error.

20. The computer program product of claim 19, wherein the computer readable program code that generates the sensitivity
subtracts the first deviation information from the second deviation, and
divides the difference by the first mask error.

21. The computer program product of claim 19, wherein the input data includes one of an edge of a layout feature and an edge of a mask feature.

22. The computer program product of claim 21, wherein the revised data includes one of:
the edge of the layout feature and a border representing the first mask error, and
the edge of the mask feature and a border representing the first mask error.

23. The computer program product of claim 21, further including computer readable program code that modulates an optical proximity correction process on the edge based on the MEEF.

24. The computer program product of claim 21, further including computer readable program code that targets an area for inspection based on the MEEF, wherein the area is provided on one of a mask and a wafer that implements the feature.

25. The computer program product of claim 24, wherein the edge of the mask feature has been corrected for optical proximity.

26. The computer program product of claim 19,
wherein the computer readable program code that receives revised data regarding the edge receives a second mask error, and
wherein the computer readable program code that simulates the revised data simulates the revised data with the first mask error, simulates the revised data with the second mask error, and uses results from at least one of simulating the revised data with the first mask error and simulating the revised data with the second mask error to generate the second deviation information.

27. A method of inspecting a mask including a plurality of features, the method comprising:
determining a subset of the plurality of features, wherein the subset exhibits a sensitivity to mask error; and
inspecting the subset of the plurality of features before other features on the mask.

28. The method of claim 27, wherein determining the subset includes:
receiving input data regarding a feature;
receiving revised data regarding the feature, wherein the revised data includes a first mask error;
simulating the input data to generate first deviation information;
simulating the revised data to generate second deviation information; and
generating a mask error enhancement factor (MEEF) using the first deviation information, the second deviation information, and the first mask error, wherein a high MEEF indicates sensitivity to mask error.

29. The method of claim 28, wherein generating the MEEF includes:
subtracting the first deviation information from the second deviation; and
dividing the difference by the first mask error.

30. A method of inspecting a wafer including a plurality of features, the method comprising:
determining a subset of the plurality of features, wherein the subset exhibits a sensitivity to mask error; and
inspecting the subset of the plurality of features before other features on the wafer.

31. The method of claim 30, wherein determining the subset includes:
receiving input data regarding a feature;
receiving revised data regarding the feature, wherein the revised data includes a first mask error;
simulating the input data to generate first deviation information;
simulating the revised data to generate second deviation information; and
generating a mask error enhancement factor (MEEF) using the first deviation information, the second deviation information, and the first mask error, wherein a high MEEF indicates sensitivity to mask error.

32. The method of claim 31, wherein generating the MEEF includes:
subtracting the first deviation information from the second deviation; and
dividing the difference by the first mask error.
